(19) United States
(12) Patent Application Publication
(10) Pub. No.: US 2008/0319639 A1
(43) Pub. Date: Dec. 25, 2008

(54) Predictive Traffic Information Creating Method, Predictive Traffic Information Creating Apparatus, and Traffic Information Display Terminal

(75) Inventor: Kenichiro YAMANE, Tokyo (JP)

Correspondence Address: CROWELL & MORING LLP;INTELLECTUAL PROPERTY GROUP, P.O. BOX 14300, WASHINGTON, DC, 20044-4300, US

(73) Assignee: Xanavi Informatics Corporation, Zama-shi (JP)

(21) Appl. No.: 11/836,546

(22) Filed: Aug. 9, 2007

(30) Foreign Application Priority Data
Aug. 18, 2006 (JP) 2006-223101

(51) Int. Cl. G08G 1/127

(52) U.S. Cl. 701/118

(57) ABSTRACT

There is provided a predictive traffic information creating method for a predictive traffic information creating apparatus connected via a communication network to a traffic information center that delivers live traffic information regarding a predetermined road network at a predetermined time interval; includes an information processor and information storage for storing at least statistical traffic information regarding links included in the road network; and when an incident occurs in the road network, creates predictive traffic information regarding after the incident. The method includes, on the information processor, receiving the live traffic information delivered from the traffic information center, and detecting the incident in the road network based on the received live traffic information; setting predictive environment parameters including parameters regarding traffic restriction in accordance with the detected incident; and creating the predictive traffic information at a time after the incident occurs based on the set predictive environment parameters and the statistical traffic information.

### CROSS-REFERENCE TO RELATED APPLICATION

This application claims the foreign priority benefit under 35 U.S.C. § 119 of Japanese Patent Application No. 2006-223101 filed on Aug. 18, 2006, the disclosure of which is incorporated herein by reference.

### BACKGROUND OF THE INVENTION

1. Field of the Invention

The present invention relates to a predictive traffic information creating method and a predictive traffic information creating apparatus for creating predictive traffic information by considering unexpected road traffic events, as well as traffic information display terminal for displaying on a display device thereof predictive traffic information created by and delivered from the predictive traffic information creating apparatus.

2. Description of the Prior Art

In a car navigation system, as a guide route for guiding a vehicle, for example, a route which minimizes the total link travel time to a destination is displayed on a map. As the link travel time data to be used when calculating such a guide route, statistical traffic information obtained by statistically processing actual data of link travel time provided from traffic information providing agencies (hereinafter, referred to as traffic information centers) such as the Japan Road Traffic Information Center, Vehicle Information and Communication System Center, and various traffic control centers of prefectures, are used.

In this specification, a road connecting a certain intersection and another intersection adjacent thereto is referred to as a link, and a necessary time for a vehicle to travel the link is referred to as a link travel time. The intersection is referred to as a node. The number of vehicles that pass a certain point, per unit time is referred to as a traffic volume.

The statistical traffic information is an average of measurements of a link travel time per each day, each time, each weekday or each holiday, etc., and is used for reproducing a traffic situation of each day. However, when an incident such as a traffic accident occurs, it is not possible to estimate a guide route which avoids the incident occurring place only based on the statistical traffic information. Therefore, conventionally, information provided from a traffic information center is attached with information on traffic congestion, accidents, and traffic restrictions in addition to the link travel time, so that the car navigation system sets greater the value of a link travel time of a link involved in traffic congestion, accidents, and traffic restrictions, thereby to estimate a guide route to avoid this link.

Generally, traffic congestion caused by an accident spreads from a link where an accident has occurred to other links in its periphery. Therefore, to estimate a guide route, link travel time of not only the link where an accident has occurred but also links around the concerned link should be set greater in value. However, the spreading range of traffic congestion depends on the accident scale and traffic volumes in the related links. Therefore, when an incident such as a traffic accident occurs, it is difficult for even an experienced and skillful person to determine how far the peripheral links reach and to how greater the link travel time in the peripheral links should be set to be. Hence, in order to calculate the link travel time as close as possible to an actual situation, some kind of simulation means becomes necessary.

Patent document 1 discloses an example of a traffic flow simulator which has both of a microscopic traffic flow simulation function and a macroscopic traffic flow simulation function. According to this traffic flow simulator, for each road (link) constituting a wide area road network, a microscopic traffic flow simulation is performed by using the road geometries and vehicle traveling performances, and macroscopic characteristic information of every road such as a traffic capacity and a traffic density property of the road are calculated. Then, for the wide area road network constituted by the links having the calculated macroscopic characteristic information, a macroscopic traffic flow simulation is performed based on an OD (Origin-Destination) traffic volume generated therein. That is, by performing the macroscopic traffic flow simulation, the OD traffic volume occurring in the wide area road network is distributed to every link such that the traffic flow distribution principle such as the first principle by John Glen Wardrop is satisfied, thereby to estimate the traffic volume and the link travel time for each link.

In this conventional traffic flow simulator, an accident or the like can be grasped as a change in traffic capacity or road geometry, so that even when an incident such as an accident occurs, a traffic volume and link travel time according thereto can be calculated. However, when an incident actually occurs, it becomes necessary to perform the microscopic traffic flow simulation once again at least for a link in which an incident occurred. Consequently, the processing load on the computer increases, and the calculation time becomes longer. In addition, when the macroscopic traffic flow simulation is performed, an OD traffic volume that is not available in the infrastructure of the traffic information management system at present is required for this simulation as input information, which brings another problem of how to get this OD traffic volume.

In Patent document 2, an example of a traffic flow simulator which has both of a microscopic traffic flow simulation function and a macroscopic traffic flow simulation function and requires no OD traffic volumes is disclosed. According to this traffic flow simulator, when an actual incident, such as an accident occurs, a microscopic implantation is performed on how vehicles move when receiving route guidance to avoid the accident place in association with the route guidance information for the vehicles.

Then, based on a traffic volume of a road that has been obtained as a result of such route guidance, further route guidance is attempted, so as to perform convergence estimation for calculating the traffic volume of the road that is obtained as a result of this further route guidance.

Similarly to the traffic flow simulator of Patent document 1, the traffic flow simulator disclosed in this Patent document 2 requires microscopic simulation; and in addition, convergence calculation is required for the route guidance calculation. Therefore, loads of these calculations on the computer inevitably increase, so that the calculation time becomes longer as well.
[Patent document 1] Japanese Published Unexamined Patent Application No. H11-144182
[Patent document 2] Japanese Published Unexamined Patent Application No. 2006-18560

As described above, in conventionally disclosed techniques, when an actual incident such as an accident occurs, arty microscopic traffic flow simulation is needed, so that the processing loads on the computer increase and the calculation time becomes longer. Therefore, in a case of a large-scale road network like a wide area road network, it is difficult to perform calculation for predictive information on traffic volumes of links and link travel time, etc. in a practical calculation time, and if this is performed, a large-scale high-performance computer would be required.

In the light of the above problems, it is desired to provide a predictive traffic information creating method and a predictive traffic information creating apparatus which can reduce the processing loads regarding predictive estimations on a computer when performing predictive calculations of traffic volumes and link travel time of those links constituting a large-scale road network, when an actual incident such as an accident occurs in the road network, and to provide a traffic information display terminal which can display the calculation results.

### SUMMARY OF THE INVENTION

In one aspect of the present invention, there is provided a predictive traffic information creating method for a predictive traffic information creating apparatus connected via a communication network to a traffic information center that delivers live traffic information regarding a predetermined road network at a predetermined time interval; includes an information processor and information storage for storing at least statistical traffic information regarding links included in the road network; and when an incident occurs in the road network, creates predictive traffic information regarding after the incident. The method includes, on the information processor, receiving the live traffic information delivered from the traffic information center, and detecting the incident in the road network based on the received live traffic information; setting predictive environment parameters including parameters regarding traffic restriction in accordance with the detected incident; and creating the predictive traffic information at a time after the incident occurs based on the set predictive environment parameters and the statistical traffic information.

In another aspect of the present invention, there is provided a predictive traffic information creating apparatus being connected via a communication network to a traffic information center that delivers live traffic information regarding a predetermined road network at a predetermined time interval. The apparatus includes an information processor; and information storage for storing at least statistical traffic information regarding links included in the road network, and when an incident occurs in the road network, creating predictive traffic information regarding after the incident. The information processor receives the live traffic information delivered from the traffic information center and detects the incident in the road network based on the received live traffic information, sets predictive environment parameters including parameters regarding traffic restriction in accordance with the detected incident; and creates the predictive traffic information at a time after the incident occurs based on the set predictive environment parameters and the statistical traffic information.

Furthermore, in another aspect of the present invention, there is provided a traffic information display terminal including an operational unit and a display, and the traffic information display terminal receives information for identifying a position or region from the operational unit, and displays traffic information regarding a road network including the location or the region. The traffic information display terminal is connected via a communication network to a predictive traffic information creating apparatus that includes information storage for storing traffic statistical information of a predetermined the road network; detects an incident in the road network based on live traffic information delivered from a traffic information center at a predetermined time interval; sets predictive environment parameters for predictive traffic information in accordance with the detected incident; and creates predictive traffic information for links of the road network based on the predictive environment parameters and the statistical traffic information. The traffic information display terminal, when the information for identifying the position or the region is input from the operational unit, acquires this input information for identifying the position or the region; transmits a request for delivery of predictive traffic information to the predictive traffic information creating apparatus, with attaching the acquired information for identifying the position or the region; receives predictive traffic information regarding the road network including the position or the region that is delivered from the predictive traffic information creating apparatus in response to the request for delivery of predictive traffic information; and displays this received predictive traffic information on a display thereof.

Other features and advantages of the present invention will become more apparent from the following detailed description of the invention when taken in conjunction with the accompanying exemplary drawings.

### DESCRIPTION OF THE DRAWINGS

FIG. 1 shows an example of a constitution of functional blocks of a predictive traffic information creating apparatus and a car navigation system according to an embodiment of the present invention;

FIG. 2 shows an example of a flow of predictive traffic information creation processing when an incident occurs by the predictive traffic information creating apparatus of the embodiment of the present invention;

FIG. 3 shows an example of data formation of live traffic information in the predictive traffic information creating apparatus of the embodiment of the present invention;

FIG. 4 shows an example of data formation of statistical traffic information in the predictive traffic information creating apparatus of the embodiment of the present invention;

FIG. 5 shows an example of prediction environment parameter record information in predictive traffic information creation processing of the embodiment of the present invention;

FIG. 6 shows points of a traffic situation prediction processing flow when an incident occurs in the predictive traffic information creating apparatus of the embodiment of the present invention;

FIG. 7 shows an example of a construction of a road network around an incident occurring link for describing the flow of traffic situation prediction processing in the predictive traffic information creating apparatus of the embodiment of the present invention;

FIG. 8 shows an example of a flow of processing of calculating predictive traffic information of boundary links in traffic situation prediction processing when an incident occurs in the predictive traffic information creating apparatus of the embodiment of the present invention;

FIG. 9 shows an example of a flow of processing of calculating predictive traffic information of upstream links in the traffic situation prediction processing when the incident occurs in the predictive traffic information creating apparatus of the embodiment of the present invention;

FIG. 10 shows a correction model of temporal transition of the restriction rate in a restricted link of the embodiment;

FIG. 11 shows an example of a distribution ratio when the stationary traffic volumes in the boundary links are distributed according to the types of the roads in the predictive traffic information creating apparatus of the embodiment of the present invention;

FIG. 12 shows procedures of a guide route search using predictive traffic information when an incident occurs in the car navigation system of the embodiment of the present invention; and

FIG. 13 shows an example of a display screen displaying a guide route in the car navigation system of the embodiment of the present invention.

### DESCRIPTION OF THE PREFERRED EMBODIMENTS

Hereinafter, an embodiment of the present invention will be described in detail with reference to the drawings.

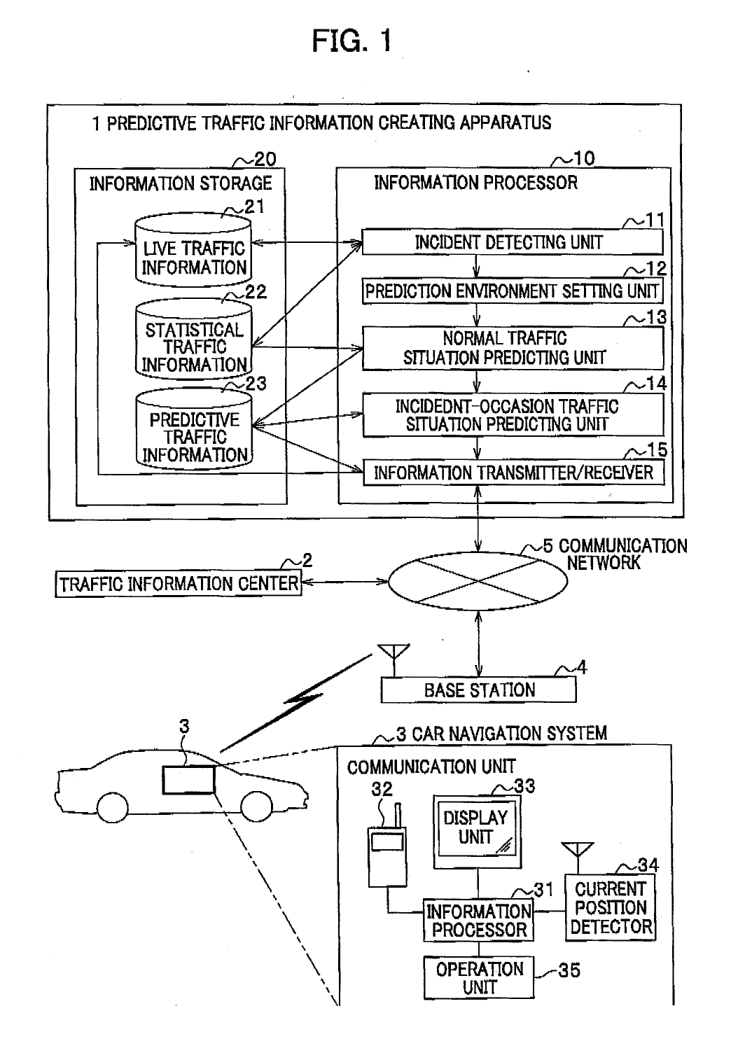

FIG. 1 shows an example of a constitution of functional blocks of a predictive traffic information creating apparatus and a car navigation system according to an embodiment of the present invention. As show in FIG. 1, the predictive traffic information creating apparatus 1 includes an information processor 10 that includes an incident detecting unit 11, a prediction environment setting unit 12, a normal traffic situation predicting unit 13, an incident occasion traffic situation predicting unit 14, information transmitter and receiver 15, and so on, and an information storage 20 that stores information such as live traffic information 21, statistical traffic information 22, predictive traffic information 23, etc.

Herein, the information processor 10 includes a CPU (Central Processing Unit), a semiconductor memory, a hard disk device (not shown), etc. The semiconductor memory or hard disk device stores predetermined programs, which are executed by the CPU, so that the functions of the functional blocks 11 through 15 constituting the information processor 10 are realized. The information storage 20 is normally composed of a hard disk device (not shown), which may be integrated with the hard disk device for the information processor 10.

The predictive traffic information creating apparatus 1 is connected to a traffic information center 2 via a communication network 5 such as the Internet, and receives delivery of live traffic information from the traffic information center 2 every predetermined time (for example, every 5 minutes). The live traffic information delivered from the traffic information center 2 is stored as live traffic information 21 in the information storage 20. The predictive traffic information creating apparatus 1 is connected to a car navigation system 3 (also referred to as a “traffic information display terminal”) installed in a vehicle via a communication network 5 and a base station 4 of a mobile phone network or the like.

The predictive traffic information creating apparatus 1 creates statistical traffic information 22 by accumulating the delivered live traffic information 21 and statistically processing this information. In addition, the predictive traffic information creating apparatus 1 detects an incident such as a traffic accident from the delivered live traffic information 21, and based on the situation of the incident and a normal traffic situation predicted from the statistical traffic information 22, creates predictive traffic information 23 and stores it in the information storage 20. Then, in response to a request from the car navigation system 3, the apparatus delivers the predictive traffic information 23 to the navigation system 3.

On the other hand, the car navigation system 3 includes an information processor 31, a communication unit 32, a display unit 33, a current position detector 34, and an operation unit 35 etc. The information processor 31 includes a CPU, a semiconductor memory, a bard disk device, and so on, and also has functional blocks of a guide route search unit and a guide route display controller that are not shown. The display unit 33 includes an LCD (Liquid Crystal Display), etc.; the communication unit 32 includes a mobile phone device, etc.; and the current position detector 34 includes a GPS (Global Positioning System) receiver, etc. The operation unit 35 includes various operation buttons, etc (not shown).

When destination information is set by a driver of the vehicle, the car navigation system 3 requests the predictive traffic information creating apparatus 1 to deliver predictive traffic information 23, and receives the information 23 delivered from the predictive traffic information creating apparatus 1 in response to the request, and then stores it in the semiconductor memory and the hard disk device, etc. The car navigation system 3 searches for a guide route from a current position acquired by the current position detector 34 to the inputted destination based on the stored predictive traffic information, and displays the searched guide route together with traffic congestion information due to an accident or the like.

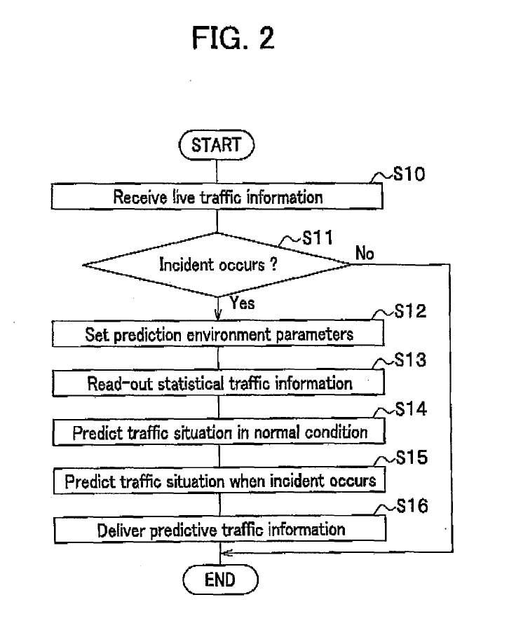

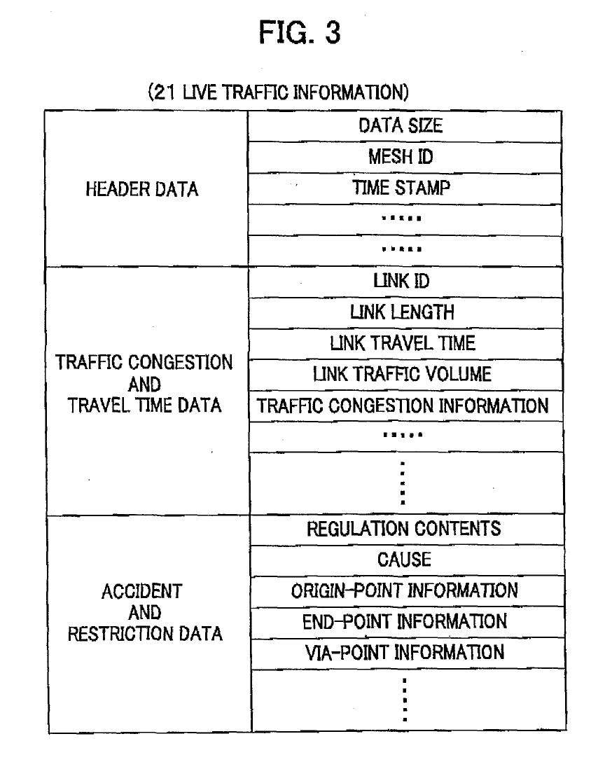

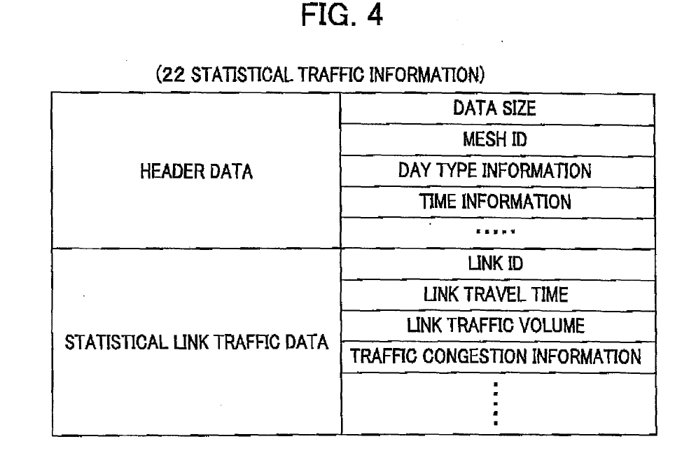

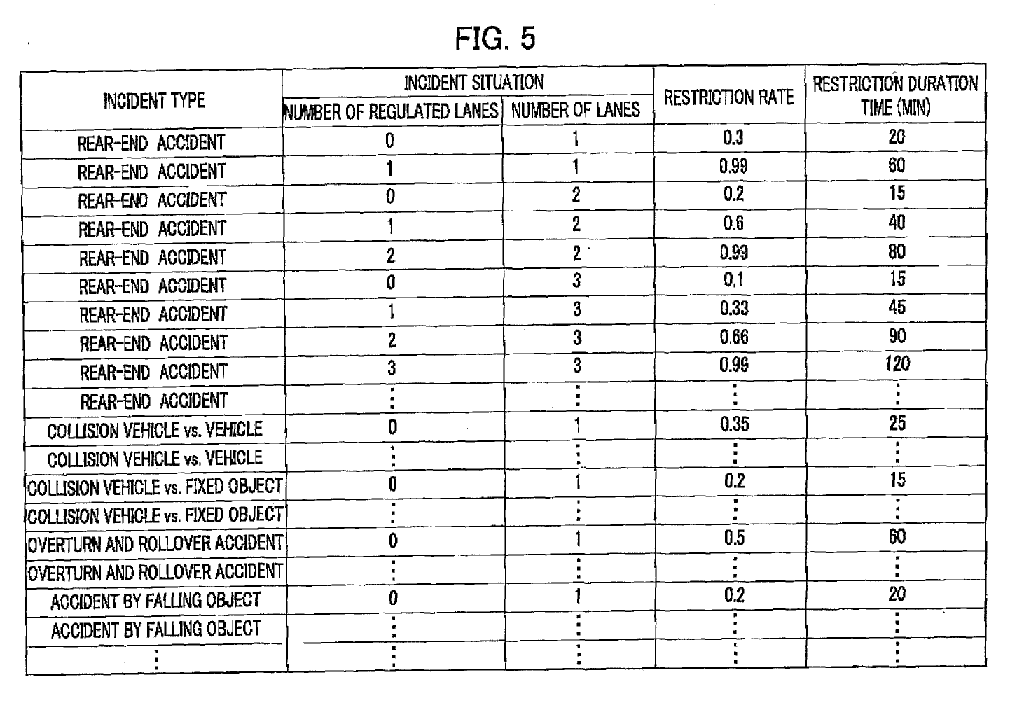

FIG. 2 shows an example of a process flow of predictive traffic information creation when an incident occurs by the predictive traffic information creating apparatus 1 of the embodiment of the present invention. FIG. 3 shows an example of data formation of live traffic information, and FIG. 4 shows an example of data formation of statistical traffic information. FIG. 5 shows an example of prediction environment parameter record information in the predictive traffic information creation processing.

As shown in FIG. 2, the information processor 10 of the predictive traffic information creating apparatus 1 receives live traffic information delivered every predetermined time from the traffic information center 2, which is a process executed by the information transmitter and receiver 15 (Step S10), and stores it as live traffic information 21 in the information storage 20. The live traffic information 21 is traffic information created based on information acquired in real time from a traffic sensor or the like installed on the road, and includes header data, traffic congestion and travel time data, and accident and restriction data.

The header data of the live traffic information 21 in FIG. 3 includes information on a data size, a mesh ID, a time stamp, etc., and the mesh ID is identification information regarding a region (divided like a mesh) from which the live traffic information was acquired, and the time stamp is information on time when the live traffic information was acquired. The traffic congestion and travel time data includes data on the respective links included in a region identified with its corresponding mesh ID, and data for each link includes a link ID, a link length, a link travel time, a link traffic volume, and traffic congestion information, etc. The accident and restriction data includes information on traffic restrictions enforced in a region identified with its corresponding mesh ID, and each piece of traffic restriction information includes contents of the restriction, a cause, origin-point information, end-point information, and via-point information.

The live traffic information 21 normally includes the above-described header data, traffic congestion and travel time data, and accident and restriction data of a plurality of regions identified with individual mesh IDs.

Next, referring to FIG. 2 again, the information processor 10 refers to the live traffic information 21 delivered from the traffic information center 2, and judges whether an incident such as a traffic accident has occurred, as a process executed by the incident detecting unit 11 (Step S11). Judgment of the occurrence of the incident can be made by judging whether or not new restriction information has been added to the live traffic information 21. Alternatively, this judgment may be performed by a method in which a change in link travel time in the live traffic information 21 is monitored, as disclosed in disclosed in Japanese Published Unexamined Patent Application No. H08-106593, for example.

The information processor 10 makes judgment of the occurrence of an incident, and if no incident occurs (No at Step S11), ends the processing of creating the predictive traffic information of FIG. 2. If an incident occurs (Yes at Step S11), the information processor sets prediction environment parameters for creating predictive traffic information, as a process executed by the prediction environment setting unit 12 (Step S12).

Herein, the prediction environment parameters includes, for example, restriction rate and restriction duration time. The restriction rate takes a value of 0 to 1, expressing a reduction rate in traffic capacity of a link in which traffic is restricted due to occurrence of an incident. Incidentally, if the restriction rate is 0.8, it means that the traffic capacity becomes 0.2. The restriction duration time means a period during which the restriction rate is applied.

These restriction rate and restriction duration time greatly change depending on the type and situation of the incident (for example, the scale of the accident, area of accident, and the type and route of the road). Therefore, in this embodiment, as shown in FIG. 5, incidents are classified by type and situation (in FIG. 5, the scale of accident is expressed as a number of restricted lanes), and those classified incidents are provided with values of restriction rate and restriction duration times experientially obtained based on the past examples, and then are stored as prediction environment parameter record information (not shown in FIG. 1) in the information storage 20.

That is, the information processor 10 judges which type and situation of the classified incidents in the prediction environment parameter record information the incident detected at Step S11 falls in, and uses restriction rate and restriction duration time values provided for the above-judged type and situation of the incidents as values of the prediction environment parameters (restriction rate, restriction duration time, etc.) for the detected incident in the subsequent processing.

Next, the information processor 10 reads-out statistical traffic information 22 from the information storage 20 as processing of the normal traffic situation predicting unit 13 (Step S13), and based on the statistical traffic information 22, when an incident docs not occur, that is, in the normal condition, the processor predicts a traffic situation (Step S14). Herein, the statistical traffic information 22 is obtained by accumulating live traffic information delivered from the traffic information center 2 and statistically processing the information, and as shown in FIG. 4, the statistical traffic information includes header data and statistical link traffic data.

The header data of the statistical traffic information 22 in FIG. 4 includes a data size, mesh IDs, day type information, and time information. The mesh ID is identification information of a target region. The day type information is information for classifying a concerned day to be statistical processed, for example, into weekday or holiday, as well as indicating whether on a weekday or holiday the statistical link traffic data subsequent from the header data is statistically taken. The time information indicates for which time data of a day the statistical link traffic data was totalized.

The statistical link traffic data is composed of data of links included in a region identified with its mesh ID, and data of each link includes a link ID, a link travel time, a link traffic volume, and traffic congestion information, etc. In this case, the link travel time, the link traffic volume, and the traffic congestion information are values (normally, averages) statistically sorted by said day type and time information.

Therefore, the prediction of the traffic situation in normal conditions can be obtained by extracting statistical link traffic data corresponding to the prediction day typo and time from the statistical traffic information 22. At this time, the extracted statistical link traffic data may be corrected as appropriate based on the live traffic information 21. The thus obtained traffic information is stored as predictive traffic information 23 in the information storage 20.

Next, for the incident detected at Step S11, the information processor 10 predicts a traffic situation when an incident occurs based on the prediction environment parameters set at Step S12 as a process executed by the incident occasion traffic situation predicting unit 14 (Step S15), and traffic information obtained based on this prediction is set as predictive traffic information 23. Then, the predictive traffic information 23 predicted at Step S14 is partially updated in connection with the incident. The details of processing of predicting the traffic situation when the unexpected situation occurs will be described later by using the drawings.

Next, the information processor 10 delivers predictive traffic information to the car navigation system 3 in response to a predictive traffic information delivery request transmitted from the car navigation system 3, as processing of the information transmitter and receiver 15 (Step S16).

In the above-described processing flow, live traffic information is delivered, for example, every 5 minutes from the traffic information center 2, so that the judgment of occurrence of an incident at Step S11 is executed at this time interval. On the other hand, traffic situation prediction when an incident occurs after S12 is performed only when an incident occurs.

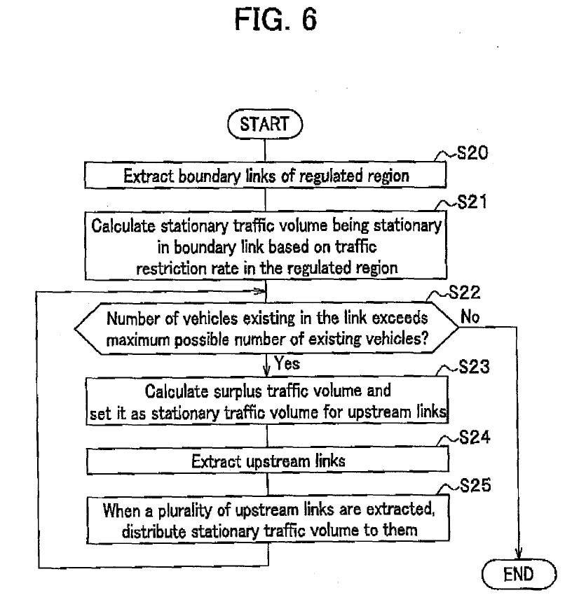

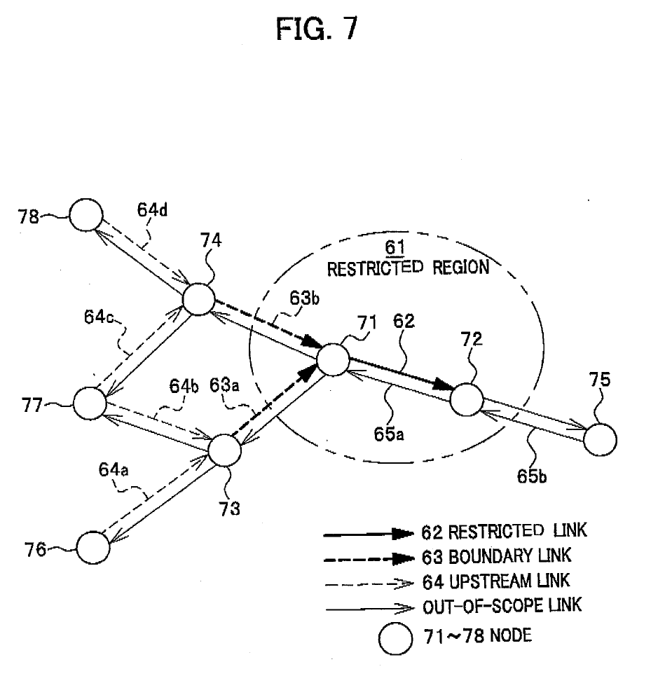

FIG. 6 shows the key points of a process flow of the traffic situation prediction at the time of an incident occurrence in the predictive traffic information creating apparatus 1 of the embodiment of the present invention. FIG. 7 shows an example of a construction of a road network around a link where the incident has occurred, thereby to explain the process flow of traffic situation prediction. Hereinafter, a calculation method for a link traffic volume and a link travel time when an incident occurs will be described by referring to FIG. 6 and FIG. 7.

The information processor 10 extracts boundary links of a restricted region by referring to road map information not shown in FIG. 1 based on the link where the incident has occurred detected at Step S11 (see FIG. 2). Note that the restricted region denotes a region defined by a link where an incident has occurred (hereinafter referred to as a “incident occurring link”), that is, a restricted link; and boundary links denotes links that are out of the restricted region and directly flow into the restricted link in the restricted region. In this case, the restricted region may include a plurality of links involved in the incident, thereby, it is possible to cope with a situation in which the traffic is restricted completely in an entire area or on roads in a particular section.

In the example of FIG. 7, the restricted region 61 includes a restricted link 62 as an incident occurring link, and to the restricted link 62, boundary links 63a and 63b are connected via a node 71. Therefore, at Step S11, the boundary links 63a and 63b are extracted. In the example of FIG. 7, the up and down roads are defined as mutually different nodes, so that an opposite link 65a of the restricted link 62 and the link 65b that flows into the opposite link via a node 72 are handled as an out-of-restriction link 65.

Next, the information processor 10 calculates a stationary traffic volume Xⱼ being stationary in the boundary link j (for example, Link 63a) based on a restriction rate c set for the restricted link k (for example, Link 62) (Step S21). This calculation is based on the following ideas.

(1) Each link j has traffic demand of a traffic volume Qⱼ obtained from the predictive traffic information 23 predicted by the normal traffic situation predicting unit 13.

(2) The sum of traffic volumes that flow into the restricted link k from a plurality of boundary links j (j=1 . . . n) is restricted by the restriction rate c of the restricted link k, and the traffic volume that flows from each boundary link j<j=1 . . . n) into the restricted link k is distributed in proportion to the traffic volume Qⱼ of the boundary link j.

Therefore, a stationary traffic volume Xⱼ that is a stationary traffic volume being in the boundary link j (i.e. the traffic volume that cannot flow into the restricted link k) is calculated by the following equation.

Xⱼ=ΣQⱼ·c·(Qⱼ/ΣQⱼ)=c·Qⱼ (Equation 1)

That is, at Step S21, the value of Equation 1 is calculated.

Equation 1 may also be interpreted as follows. The stationary traffic volumes Xⱼ which cannot flow into the restricted link k from the plurality of boundary links j (j=1 . . . n) and stationary in the boundary links j can be calculated by distributing stationary traffic volumes in all boundary links in proportion to the predictive traffic volumes Qⱼ in normal conditions of the boundary links j.

Next, the information processor 10 judges whether or not the number of existing vehicles Eⱼ in the boundary link j has exceeded a maximum possible number of existing vehicles Emaxⱼ in this boundary link j (Step S22). At this time, the stationary traffic volume Xⱼ calculated by Equation 1 is added to the number of existing vehicles Eⱼ in the boundary link j, and a traffic volume Zⱼ to be cleared up at a minimum travel speed V0 is subtracted therefrom. Specifically, at Step S22, it is judged whether the following equation is established or not.

Eⱼ+Xⱼ−Zⱼ>Emaxⱼ (Equation 2)

Herein, the maximum possible number of existing vehicles Emaxⱼ is calculated by Equation 3, where k0j is the saturated traffic density of the boundary link j, Lⱼ is the link length, and mⱼ is the number of lanes.

Emaxⱼ=k0j·Lⱼ·mⱼ (Equation 3)

The traffic volume Zⱼ to be cleared up at a minimum travel speed V0j is calculated by Equation 4, where k0ⱼ, the saturated traffic density of the boundary link j.

Zⱼ=k0ⱼ·V0ⱼ (Equation 4)

Generally, the values of the saturated traffic density k0j and the minimum speed V0j vary on individual roads, that is, links. Therefore, these values may be calculated in advance by using a known microscopic traffic flow simulator or the like and stored as a part of the link data of the road map information in the information storage 20. Alternatively, instead of using those values different among links, values may be properly sorted by road type such as national road, prefectural road, and expressway, and the sorted values may be stored in the information storage 20.

Generally, the number of existing vehicles Eᵢ in the link i is calculated by Equation 5 or Equation 6, where Qⱼ is the traffic volume of the link i, Vᵢ is the vehicle speed, Lᵢ is the link length, Tᵢ is the link travel time, and mᵢ is the number of lanes.

When the traffic density Kᵢ(=Qⱼ/Vᵢ) is equal to or less than the saturated traffic density k0i,

Eᵢ=Qᵢ·Lᵢ/Vᵢ=Qᵢ·Tᵢ (Equation 5),

when the traffic density kᵢ (=Qᵢ/Vᵢ) is larger than the saturated traffic density k0ᵢ,

Eᵢ=k0ᵢ·Lᵢ·mᵢ (Equation 6)

Therefore, the number of existing vehicles Eⱼ in the boundary link j in Equation 2 is calculated by substituting into Equation 5 or Equation 6 the values of the traffic volume Qⱼ and the link travel time Tⱼ readout from the statistical traffic information 22, that is, from the predictive traffic information 23 predicted by the normal traffic status predicting unit 13, as well as the values of the link length Lⱼ and the number of lanes mⱼ of the boundary link j readout from the road map information.

Next, the information processor 10 executes the process from Step S21 to Step S22 described above for every boundary link j extracted at Step S20. Then, when the number of existing vehicles in every boundary link j becomes less than the maximum possible number of existing vehicles (No at Step S22), the processing is ended. On the other hand, if at least one of the boundary links j has the number of existing vehicles in the link that exceeds the maximum possible number of existing vehicles (Yes at Step S22), the information processor 10 calculates a surplus traffic volume Yⱼ of this boundary link j, and sets the calculated surplus traffic volume Yⱼ as a stationary traffic volume to an upstream link of this boundary link j (Step S23). Herein, the surplus traffic volume Yⱼ is calculated by the following equation.

Yⱼ=Eⱼ+Xⱼ−Zⱼ−Emaxⱼ (Equation 7)

Next, the information processor 10 extracts upstream links u connected to the boundary link j with the surplus traffic volume Yⱼ on the upstream side by referring to the road map information (Step S24). For example, in FIG. 7, the upstream links of the boundary link 63a are 64a and 64b, and the upstream links of the boundary link 63b are 64c and 64d.

Next, when one boundary link j has a plurality of upstream links u, the information processor 10 distributes the stationary traffic volume (that is, the surplus traffic volume Yⱼ) to the upstream links u obtained at Step S23 (Step S25). This distribution is performed in proportion to the traffic volumes Qᵤ of the respective upstream links u, as in the case of Step S21. That is, the stationary traffic volume Xᵤ in each upstream link u is calculated according to the following equation.

Xᵤ=Yⱼ·(Qᵤ/ΣQᵤ) (Equation 8)

After calculating the stationary traffic volume Xᵤ for each upstream link u, the information processor 10 replaces the upstream link u with the boundary link j and repeatedly executes the processes after Step 22. The repeated executions of the processes allow another surplus traffic volume Yu if occurred in any upstream link u to be distributed to further upstream links thereof as a stationary traffic volume.

The information processor 10 can diffuse a stationary traffic volume to upstream links in time, as well as geometrically as described above. Herein, such a stationary traffic volume to be diffused in time is referred to as an uncleared traffic volume. A process for such an uncleared traffic volume will be supplementarily described, hereinafter.

The information processor 10 calculates a number of uncleared vehicles ΔEⱼ(t) at the time (t) of the boundary link j according to the following Equation 9.

ΔEⱼ(t)=Xⱼ(t)−Zⱼ (Equation 9)

Then, of these number of uncleared vehicles ΔEⱼ(t), the number of uncleared vehicles ΔEⱼ(t+Δt) that still remain at the time (t+Δt) after a unit time (Δt) passed is calculated by the following equation with the restriction rate c.

ΔEⱼ(t+Δt)=c·ΔEⱼ(t) (Equation 10)

Next, the information processor 10 adds the number of uncleared vehicles ΔEⱼ(t+Δt) calculated by Equation 10 to the number of existing vehicles ΔEⱼ(t+Δt) of the boundary link j at the time (t+Δt) that has been obtained by Equation 5 or Equation 6, and calculates the corrected number of existing vehicles E′ⱼ(t+Δt) by using the following equation.

E′ⱼ(t+Δt)=Eⱼ(t+Δt)+ΔEⱼ(t+Δt) (Equation 11)

Next, when this corrected number of existing vehicles E′ⱼ(t+Δt) exceeds the maximum possible number of existing vehicles Emaxⱼ of the boundary link j, the number of excessive existing vehicles Yeⱼ(t+Δt) at the time (t+Δt) of the boundary link j is calculated by the following equation.

Yeⱼ(t+Δt)=E′ⱼ(t+Δt)−Emaxⱼ (Equation 12)

This number of excessive existing vehicles Yeⱼ(t+Δt) corresponds to the surplus traffic volume Yⱼ obtained by Equation 7, and in the same manner as in processing of diffusing the surplus traffic volume Yⱼ as a stationary traffic volume to the upstream links u, the number of excessive existing vehicles Yeⱼ(t+Δt) is diffused to the upstream links u. Then, the diffusion processing is continued until Yeⱼ(t+Δt) reaches 0 (or less).

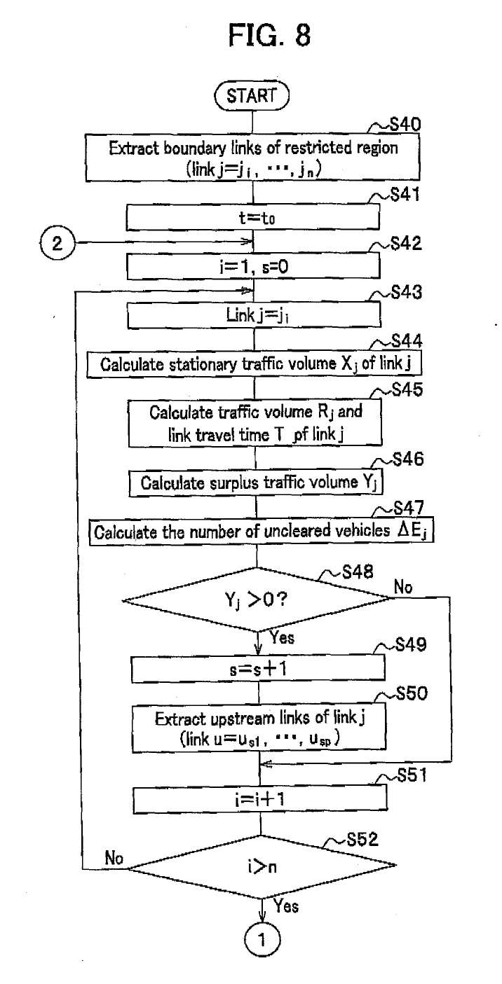

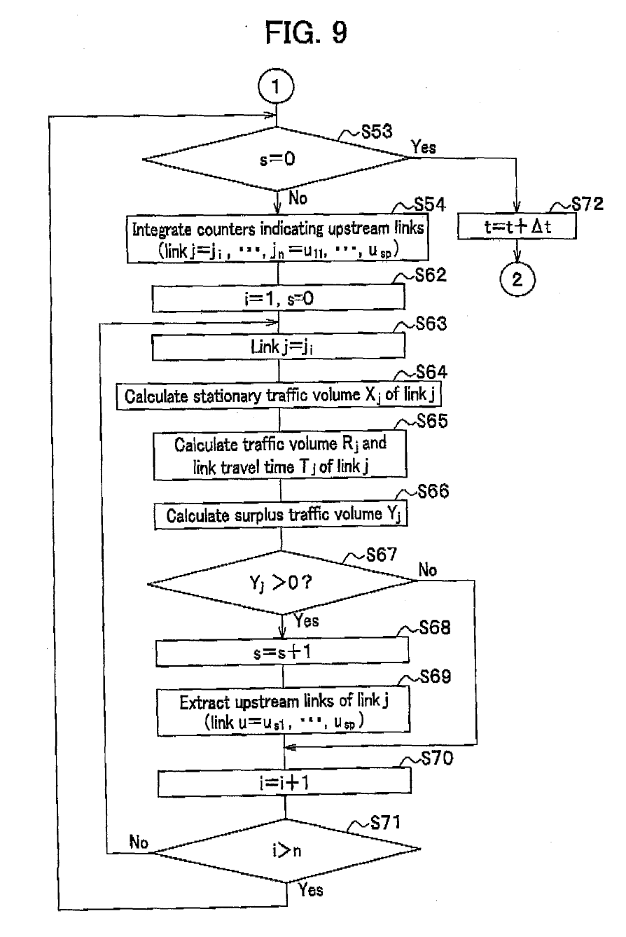

FIG. 8 shows an example of a process flow of calculating predictive traffic information of boundary links in traffic situation prediction process when an incident occurs in the predictive traffic information creating apparatus of the embodiment of the present invention, and FIG. 9 shows an example of a process flow of calculating predictive traffic information of upstream links, of the traffic situation prediction process when the incident occurs.

As shown in FIG. 8, the information processor 10 extracts first the boundary links j (j=j₁, . . . , jₙ) of the restricted region by referring to the road map information (Step S40). Herein, n denotes the number of boundary links. Next, the information processor 10 sets a restriction start time t=t₀, deeming that restriction for the links of the restricted region has been started (Step S41), and furthermore, initializes a counter i that indicates the boundary link j and a counter s that indicates the number of upstream links u, such that set i=1 and s=0 (Step S42).

Subsequently, the information processor 10 sets the boundary link to be processed as link j=jᵢ (Step S43), and calculates a stationary traffic volume Xⱼ at the time t when an incident occurs according to Equation 1 (Step S44). Next, the information processor calculates a traffic volume Rⱼ and link travel time Tⱼ of the link j, taking account of this stationary traffic volume Xⱼ (Step S45). At this time, the traffic volume Rⱼ and the link travel time Tⱼ are calculated as follows.

First, the corrected number of existing vehicles E′ⱼ (=Eⱼ+Xⱼ−Zⱼ) of the link j is calculated, and based on the corrected number of existing vehicles E′ⱼ, the traffic density Kⱼ (=E′ⱼ/Lⱼ, where k0ⱼ if Kⱼ>k0) of the link j is calculated. Then, based on the so-called Greenshields' relationship, the vehicle speed (link travel speed) Vⱼ is calculated.

Herein, the Greenshields' relationship is an experiential expression of the relationship between the traffic density K and the travel speed V of the link, and is provided as the following (Equation 13).

V={(V0−Vf)/k0}·K+Vf (Equation 13)
where, if K>k0, V=V0

Note that k0 denotes a saturated traffic density, Vf denotes a predetermined maximum speed (for example, restricted maximum speed of the link), and V0 denotes a predetermined minimum speed.

Next, based on the traffic density Kⱼ and the vehicle speed Vⱼ calculated as described above, the traffic volume Eⱼ (=Kⱼ·Vⱼ) and the link travel time Tⱼ (=Lⱼ/Vⱼ) are calculated. The thus calculated traffic volume Rⱼ and link travel time Tⱼ correspond to predictive traffic information of the link j at the time t.

Subsequently, the information processor 10 calculates the surplus traffic volume Yⱼ by Equation 7 (Step S46), and calculates the number of uncleared vehicles ΔEⱼ by Equation 9 (Step S47). Then, it is judged whether or not a surplus traffic volume Yⱼ occurs, that is, whether it is Yⱼ>0 or not, and if Yⱼ>0 (Yes at Step S48), the counter s is incremented by +1 (Step S49), and upstream links u (u=uₛ₁ . . . uₛₚ) of the link j are extracted by referring to the road map information (Step S50). If it is hot Yⱼ>0 (No at Step S48), no surplus traffic volume occurs, so that it is not necessary to extract upstream links, and Steps S49 and S50 are skipped.

The information processor 10 finishes the process for one boundary link j by executing the above described processes, and subsequently, in order to perform a process for the next boundary link j, the information processor increments the counter i by +1, so that the counter i indicates for the next boundary link j (Step S51). Then, the information processor judges whether or not the counter i has exceeded the number of boundary links n (i>n), and if the number of boundary links n is not exceeded (not i>n) (No at Step S52), returns to Step S43, and repeats the process after Step S43. If the counter i exceeds the number of boundary links j (i>n) (Yes at Step S52), this means that the processing has been completed for all boundary links, so that processes for upstream links shown in FIG. 9 are executed subsequently.

Next, as shown in FIG. 9, first, the information processor 10 judges whether the counter s is 0 or not, and if the counter s is not 0 (No at Step 53), the counters indicating the upstream links u (subscripts of u) extracted at Step S50 are integrated. Specifically, if there are a plurality of boundary links j, a counter for indicating upstream links u is set for each boundary link at Step S50, therefore, the counters are needed to be numbered in order. Now, the upstream links u are translated into links j. Thereby, the predictive traffic information of the upstream links u can be calculated in substantially the same manner as in the calculation of the predictive traffic information of the boundary links.

That is, the processes from Step S62 through Step S71 are substantially the same as the processes from Step S42 through Step S52 of FIG. 8. Therefore, description thereof is omitted. However, when the stationary traffic volume Xⱼ is calculated at Step S64, Equation 8 is used instead of Equation 1. In this case, the calculation of the number of uncleared vehicles ΔEⱼ is not performed. These processes are repeated until the surplus traffic volume Yⱼ does not occur and no more upstream links u are extracted (s=0).

On the other hand, when the counter s is judged to be 0 at Step S53 (Yes at Step S53), this means that no uncleared upstream link exists, so that the information processor 10 completes the calculation of the predictive traffic information at the time t. Then, the time t is put forward by unit time Δt, that is, t=t+Δt is set (Step S72), and the process returns to Step S42, so as to repeat the process after Step S42.

When calculating the predictive traffic information at the time (t+Δt), the information processor 10 uses the number of uncleared vehicles ΔEⱼ calculated at Step S47 (see FIG. 8) to calculate the predictive traffic information. The calculation procedure thereof is as described above in Equation 9 through Equation 12, and a process flow thereof is approximately the same as those shown in FIG. 8 and FIG. 9, therefore, description thereof is omitted. However, the differences are as follows.

At Step S45 and Step S65, as for the traffic volume (predictive traffic volume in normal conditions) serving as a basis of the calculation of the traffic volume Rⱼ and link travel time Tⱼ of the link j, a value obtained by adding the traffic volume Qⱼ readout from the statistical traffic information 22 and the number of uncleared vehicles ΔEⱼ(t) obtained by Equation 9 is used. At Step S46 and Step S66, instead of calculating the surplus traffic volume Yⱼ, the number of excessive existing vehicles Yeⱼ (t+Δt) is calculated by using Expression 12. At Step S48 and Step S67, judgment is made based on whether or not the number of excessive existing vehicles Yeⱼ(t+Δt) is greater than 0 (>0) instead of whether or not the surplus traffic volume Yⱼ is greater than 0 (>0).

After the time unit (t+Δt) passes, the information processor 10 repeatedly executes the above described process at every time unit, that is, repeatedly and continuously executes the process at every time (t+Δt), (t+2·Δt), (t+3·Δt) . . . and so on until the number of excessive existing vehicles Yeⱼ(t+n·Δt) becomes zero in all the links after the preset restriction duration time of the incident is over.

As described above, in this embodiment, when an incident occurs, the information processor 10 diffuses the stationary traffic volume Xⱼ in the boundary link j that cannot flow into the restricted link 62 of the restricted region 61 is diffused to upstream links, and a traffic volume that could not be cleared up in a certain unit time is added to the traffic volume after this unit time. Then, based on a resultant link traffic density and the Greenshields' relationship (mathematical model), predictive traffic information (traffic volume, link travel time, etc.) is calculated.

In these processes, a microscopic simulation is not performed, and for only the boundary links j and the upstream links u to which the stationary traffic volume Xⱼ from the boundary links j was diffused, predictive traffic information is calculated. That is, the processes are not performed for the other links that are not influenced by the incident. Therefore, according to this embodiment, the processing load on the computer can be made smaller, and the calculation time is also reduced. Therefore, without using a large-scale high-performance computer, predictive traffic information for a large-scale road network when an incident occurs can be calculated in a shorter time.

When the inventors of the present invention calculated predictive traffic information by using a computer by using a real traffic accident as a model based on the predictive traffic information calculation processes described above, it was found that a part of the predictive traffic information was not consistent with the real information. This means, when the accident is completely cleared up and the road traffic restriction is removed, the traffic congestion is solved far more quickly than actual. A method for correcting this to match up to the actual situation will be supplementarily described, hereinafter.

In the above-described predictive traffic information calculation, when the road traffic restriction is removed, the restriction rate c of this road, that is, the restriction link is processed so as to become zero immediately (c=0). Therefore, the stationary traffic volume Xⱼ in the boundary link j obtained by Equation 1 becomes zero immediately. Therefore, after a short time elapses, the number of uncleared vehicles ΔEⱼ calculated by Equation 9 becomes zero, and the traffic congestion is quickly solved and the traffic situation restores to the normal situation.

On the other hand, in actuality, even after the road traffic restriction is removed, the traffic congestion is not quickly solved. The reason for this is that even after the road traffic restriction is removed, the actual traffic capacity of the road does not return to the original traffic capacity. For example, even after the restriction is removed, many vehicles passing through the accident location slow down, which corresponds to a phenomenon that the traffic capacity is lowered.

Therefore, in the calculation of the predictive traffic information, the restriction rate c of the restricted link is corrected to be zero, not immediately after the restriction is removed, but after the restriction is removed, so that the restriction rate c gradually decreases along the straight line of the negative gradient. In other words for this case, in order to express the delay of the restoration of the traffic capacity, the restriction rate c is gradually reduced.

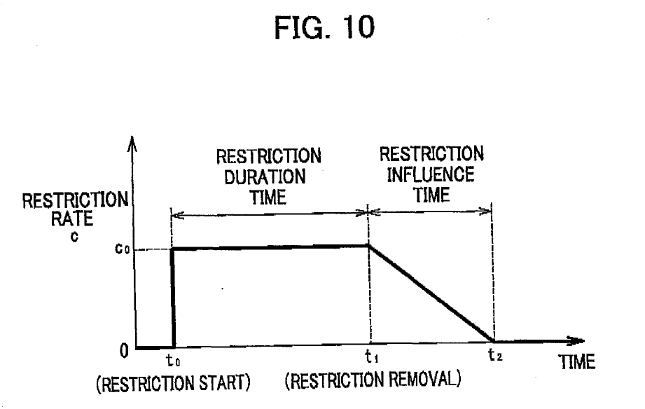

FIG. 10 shows a correction model of time transition of the restriction rate in a restricted link according to this embodiment. As shown in FIG. 10, in the corrected model, the restriction rate c is set to be c=0 before the restriction (before time t₀); and to be c=c₀ from the restriction start (time t₀) to the restriction removal (time t₁). Then, after the restriction removal time (time t₁), the restriction rate c gradually decreases down to c=0 along the straight line c=c₀−a(t−t₁)(a>0). The restriction rate is maintained to be c=0 after the time (t₂) when the restriction rate c reaches c=0.

Herein, the period from the restriction removal time (time t₁) to the timing at which c becomes 0 (time t₂) is referred to as a restriction influence time. The restriction influence time differs depending on the type and situation of the incident such as an accident, a cause of the restriction. If the restriction duration time lingers, the restriction influence time seems to linger as well. Therefore, in the same manner as for the restriction duration time, for the restriction influence time, experiential values obtained based on the past events according to the type and situation of the incident are also stored as prediction environment parameter record information (see FIG. 5, although the restriction influence time is not shown) in the information storage 20.

That is, the information processor 10 determines the restriction influence time by judging which type and which situation classified in prediction environment parameter record information the incident detected at Step S11 falls in, in the process executed by the prediction environment setting unit 12 (Step S12, see FIG. 2) in the same manner as determination of the restriction rate and restriction duration time.

As described above, in this embodiment, the restriction rate c is set to be c=0 not immediately after the restriction is removed, but is expressed by a straight line gradually descending from c=c₀, thereby to improve an accuracy of the predictive traffic information obtained by the predictive traffic information calculation.

In the above-described predictive traffic information calculation processing, when a plurality of boundary links are connected to the restricted link, the stationary traffic volumes that cannot flow into the restricted link from the boundary links and stays in the boundary links are distributed in proportion to the predictive traffic volumes in normal conditions of the boundary links (see Equation 1). Equivalently, the stationary traffic volumes that cannot flow into downstream links from upstream links and are still stationary in the upstream links are also distributed in proportion to the predictive traffic volumes in normal conditions of the upstream links (see Equation 8).

However, the distributions of the stationary traffic volume to the boundary links or upstream links is not limited to this assumption. The stationary traffic volumes in the boundary links or the upstream links may be distributed in accordance with a predetermined distribution rate depending on the type of the road, (such as expressway, national road, prefectural road, and other road) of the boundary links or upstream links.

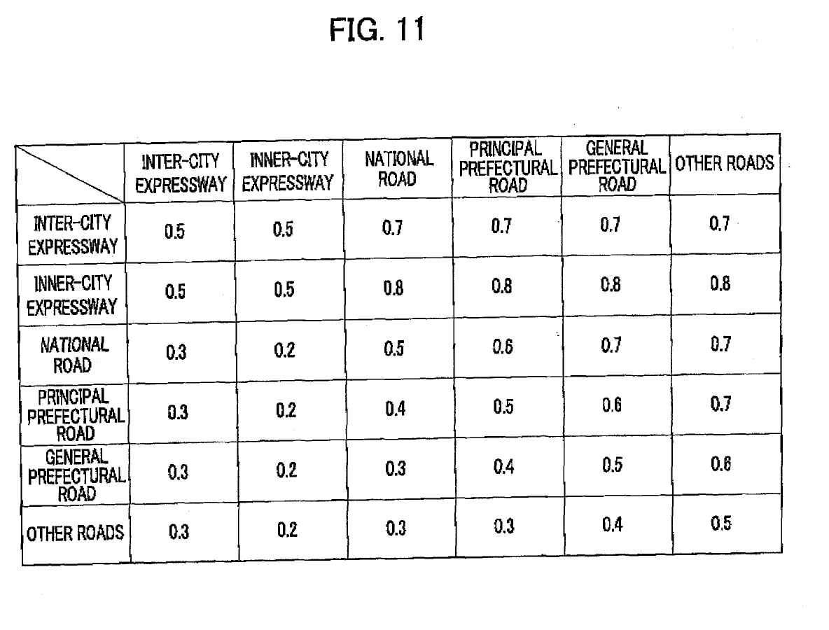

FIG. 11 shows an example of a distribution rate for the stationary traffic volume in the boundary links to be distributed depending on the type of the road. For example, in FIG. 11, it is assumed that the upstream links that flow into a certain link are a national road and a general prefectural road. 0.7 (70%) of the traffic volume to be flown into the link would be stationary in the national road, and 0.3 (30%) thereof would be stationary in the prefectural road. However, this distribution rate is experientially determined based on the past events, and is not limited to the values exemplified in FIG. 11.

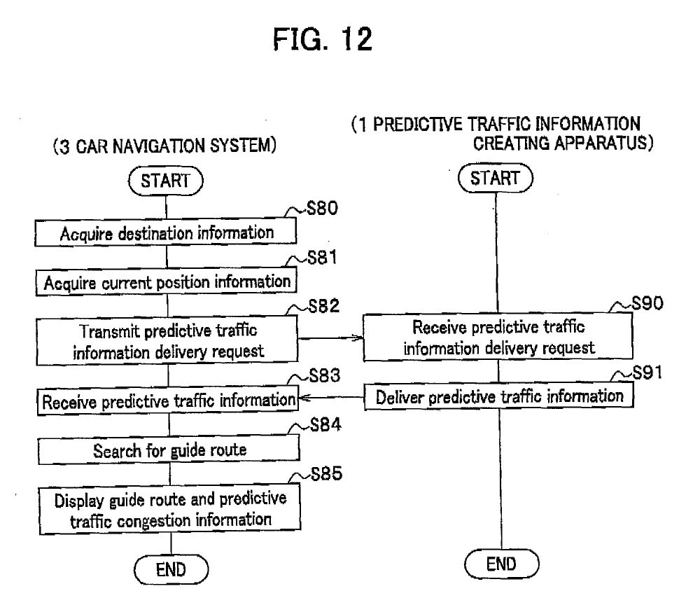

FIG. 12 shows procedures of a guide route search using predictive traffic information when an incident occurs in a car navigation system according to an embodiment of the present invention. As shown in FIG. 12, the car navigation system 3 acquires destination information set by a driver with an operation button (not shown) of the operation unit 35, or the like (Step S80), and acquires a current position of the vehicle detected by the current position detector 34 (Step S81). Then, the car navigation system 3 transmits a delivery request of predictive traffic information with attaching the acquired destination information and the current position, to the information processor 10 (Step S82).

The predictive traffic information creating apparatus 1 receives this predictive traffic information delivery request (Step S90) and delivers predictive traffic information 23 (see FIG. 1) stored in the information storage 20 to the car navigation system 3 that transmitted the predictive traffic information delivery request (Step S91). If a predetermined restriction duration time passes after an incident occurs and it is before the restriction influence time passes, the predictive traffic information 23 is predicted by the expected event occasion traffic situation predicting unit 14. In other cases, the traffic information 23 is predicted by the normal traffic situation predicting unit 13.

When receiving the predictive traffic information delivered from the predictive traffic information creating apparatus 1 (Step S83), the car navigation system 3 searches for a guide route from the current position to the destination (Step S84) based on the received predictive traffic information, and displays the searched guide route and predictive traffic congestion information on the display unit 33 together with a road map including the current position of the vehicle and the guide route (Step S85).

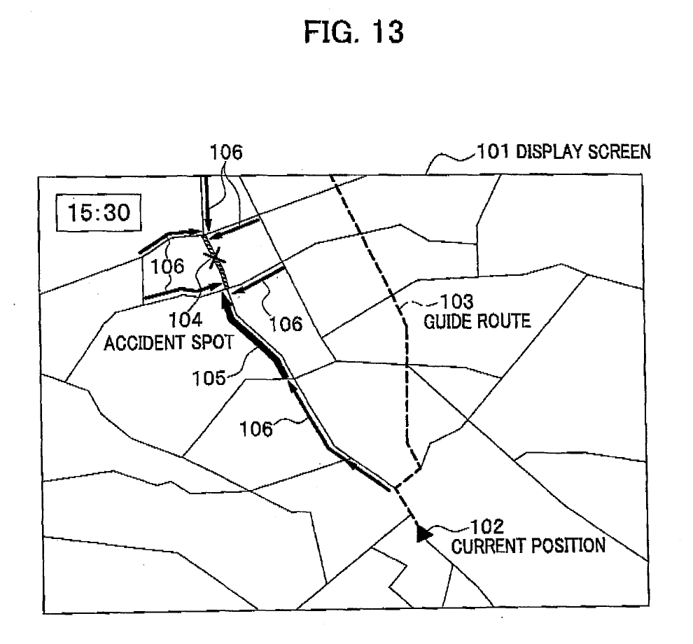

FIG. 13 shows an example of a display screen displaying a guide route in a car navigation system according to the embodiment of the present invention. As shown in FIG. 13, on the display screen 101 of the display unit 33 of the car navigation system 3, a road map including the current position 102 of the vehicle and the guide route 103 are displayed. Then, at this time, if an incident such as an accident occurs, an accident spot 104 is displayed on the road map, and furthermore, traffic congestion situations of links around the accident spot 104 are displayed, for example, by differences in line thickness, line color, line type and the like. In the example of FIG. 13, the traffic congestion situations are represented by differences in line thickness, in which the link highlighted by a thick line 105 shows a heavily congested state, and the link indicated by a medium-thick line 106 shows a congested state.

The predictive traffic information delivered from the predictive traffic information creating apparatus 1 has substantially the same constitution as of the statistical traffic information shown in FIG. 4, and has traffic congestion information as information of each link. Therefore, the predictive traffic information creating apparatus 1 can add the traffic congestion levels determined depending on the travel speed (vehicle speed) of the links as the traffic congestion information. This allows the car navigation system 3 to display traffic congestion levels easily.

Traffic congestion information displayed at this step is traffic congestion information at the time when the car navigation system 3 displays the guide route (i.e. current time). When the accident spot 104 is far from the current position 102, the driver of the vehicle may want to know not only the current traffic congestion situation but also the future traffic congestion situation.

Therefore, as traffic congestion information displayed herein, for example, traffic congestion information at a future time may be further displayed. The predictive traffic information delivered from the predictive traffic information creating apparatus 1 also includes traffic information at a future time, so that, for example, when the driver of the vehicle designates the traffic congestion information 10 minutes ahead from the current time, traffic congestion information 10 minutes ahead is displayed based on the predictive traffic information at the future time.

As for traffic congestion information displayed herein, for example, volumes based on stationary traffic volumes Xⱼ in boundary links j calculated in the processing of the incident occasion traffic situation predicting unit 14 may be further displayed. Because the stationary traffic volume Xⱼ is a traffic volume that cannot flow out from the link j and is stationary, so that a link with a greater stationary volume is likely to have a higher possibility that the traffic congestion will become worse.

In the car navigation system 3 according to the embodiment of the present invention, when the above-described traffic congestion is displayed, may also be configured to recognize the difference between traffic congestion information based on predictive traffic information for a case of an incident occurrence and traffic congestion information based on predictive traffic information for a case of no incident occurrence. For example, in FIG. 13, the thicknesses of the lines 105 and 106 indicating the traffic congestion situations of the concerned links are defined, not by the traffic congestion distance, but based on a comparison between the predictive congestion distance in a case in which an incident occurs and that of the other case.

As described above, by displaying the predictive traffic information delivered from the predictive traffic information creating apparatus 1 on the display unit 33 of the car navigation system 3 in various manners, the convenience of the car navigation system 3 can be increased. In addition, according to the predictive traffic information creating apparatus 1 of the present invention, the predictive traffic information calculation process can be performed in a shorter time, so that the car navigation system 3 can receive delivery of predictive traffic information in a shorter time after an incident occurs

In the embodiment described above, descriptions have been given by assuming that the apparatus which receives and displays predictive traffic information delivered from the predictive traffic information creating apparatus 1 is the car navigation system 3; however, it is not limited to the car navigation system 3. The apparatus which receives and displays predictive traffic information may be a personal computer installed in an office or a house, a portable personal digital assistance, or a mobile phone as far as it is connectable to the predictive traffic information creating apparatus 1 via a communication network 5.

According to the present invention, the processing load on a computer when creating predictive traffic information of links constituting a road network when an incident such as an accident occurs in the road network is reduced.

The embodiments according to the present invention have been explained as aforementioned. However, the embodiments of the present invention are not limited to those explanations, and those skilled in the art ascertain the essential characteristics of the present invention and can make the various modifications and variations to the present invention to adapt it to various usages and conditions without departing from the spirit and scope of the claims.

What is claimed is:

1. Predictive traffic information creating method for a predictive traffic information creating apparatus:
being connected via a communication network to a traffic information center that delivers live traffic information regarding a predetermined road network at a predetermined time interval;
comprising an information processor and information storage for storing at least statistical traffic information regarding links included in the road network; and
when an incident occurs in the road network, creating predictive traffic information regarding after the incident,
the method comprising:
on the information processor,
receiving the live traffic information delivered from the traffic information center, and detecting the incident in the road network based on the received live traffic information;
setting predictive environment parameters including parameters regarding traffic restriction in accordance with the detected incident; and
creating the predictive traffic information at a time after the incident occurs based on the set predictive environment parameters and the statistical traffic information.

2. A predictive traffic information creating method according to claim 1 further comprising:
on the information processor,
setting a restriction rate that restricts traffic volume in a restricted link included in a region where the incident has occurred as the predictive environment parameter;
extracting at least one boundary link that is connected to an upper side of the restricted link with reference to road map information including connection information on links in the road network;
calculating stationary traffic volume that cannot flow from the boundary link into the restricted link and stays in the boundary link based on normal time predictive traffic volume acquired from the statistical traffic information and the restriction rate for the restricted link;
creating predictive traffic information regarding the boundary link based on normal time predictive traffic volume and the calculated stationary traffic volume of the boundary link;
creating predictive traffic information of at least one upper link that is connected to a upper side of the boundary link based on normal time predictive traffic volume and stationary traffic volume of the upper link if there occurs any stationary traffic volume in the upper link due to the stationary traffic volume of the boundary link; and
of the stationary traffic volume of the boundary link, if there occurs any uncleared traffic volume that cannot flow out of the boundary link within a predetermined unit time, adding this uncleared traffic volume to traffic volume of the boundary links in a following unit time.

3. The predictive traffic information creating method according to claim 2 wherein,
if a plurality of boundary links are connected to the restricted link, stationary traffic volume of each boundary link is distributed in proportion to the normal time predictive traffic volume of each boundary link by the information processor.

4. The predictive traffic information creating method according to claim 2 wherein,
if a plurality of boundary links are connected to the restricted link, stationary traffic volume of each boundary link is distributed in accordance with a predetermined distribution rate depending on the type of a road of each boundary link by the information processor.

5. The predictive traffic information creating method according to claim 1 wherein,
the predictive environment parameters that have been predetermined in accordance with the types and situations of incidents are stored in information storage; and
with reference to this information storage, the predictive environment parameter in accordance with the type and situation of the detected incident is set based on the live traffic information by the information processor.

6. A predictive traffic information creating apparatus being connected via a communication network to a traffic information center that delivers live traffic information regarding a predetermined road network at a predetermined time interval,
the apparatus comprising:
an information processor; and
information storage for storing at least statistical traffic information regarding links included in the road network, and when an incident occurs in the road network, creating predictive traffic information regarding after the incident,
the information processor:
receiving the live traffic information delivered from the traffic information center, and detecting the incident in the road network based on the received live traffic information;
setting predictive environment parameters including parameters regarding traffic restriction in accordance with the detected incident; and
creating the predictive traffic information at a time after the incident occurs based on the set predictive environment parameters and the statistical traffic information.

7. A predictive traffic information creating apparatus according to claim 6, wherein
the information processor:
setting a restriction rate that restricts traffic volume in a restricted link included in a region where the incident has occurred as the predictive environment parameter;
extracting at least one boundary link that is connected to an upper side of the restricted link with reference to road map information including connection information on links in the road network;
calculating stationary traffic volume that cannot flow from the boundary link into the restricted link and stays in the boundary link based on normal time predictive traffic volume acquired from the statistical traffic information and the restriction rate for the restricted link;
creating predictive traffic information regarding the boundary link based on normal time predictive traffic volume and the calculated stationary traffic volume of the boundary link;
creating predictive traffic information of at least one upper link that is connected to a upper side of the boundary link based on normal time predictive traffic volume and stationary traffic volume of the upper link if there occurs any stationary traffic volume in the upper link due to the stationary traffic volume of the boundary link; and
of the stationary traffic volume of the boundary link, if there occurs any uncleared traffic volume that cannot flow out of the boundary link within a predetermined unit time, adding this uncleared traffic volume to the traffic volume of the boundary links in a following unit time.

8. A predictive traffic information creating apparatus according to claim 7, wherein
if a plurality of boundary links are connected to the restricted link, the information processor distributes stationary traffic volume of each boundary link in proportion to the normal time predictive traffic volume of each boundary link.

9. The predictive traffic information creating apparatus according to claim 7 wherein,
if a plurality of boundary links are connected to the restricted link, the information processor distributes stationary traffic volume of each boundary link in accordance with a predetermined distribution rate depending on the type of a road of each boundary link.

10. A predictive traffic information creating apparatus according to claim 6 wherein,
the information storage stores the predictive environment parameters that have been predetermined in accordance with the types and situations of incidents; and
with reference to the information storage, the information processor sets the predictive environment parameter in accordance with the type and situation of the detected incident based on the live traffic information.

11. A predictive traffic information creating apparatus according to claim 6 further being connected via the communication network to a traffic information display terminal that displays traffic information including the predictive traffic information,
and wherein
when receiving a request for delivery of predictive traffic information that is transmitted from the traffic information display terminal, the information processor transmits the created predictive traffic information to the traffic information display terminal.

12. A predictive traffic information creating apparatus according to claim 7 further being connected via the communication network to a traffic information display terminal that displays traffic information including the predictive traffic information,
and wherein
when receiving a request for delivery of predictive traffic information that is transmitted from the traffic information display terminal, the information processor transmits the created predictive traffic information to the traffic information display terminal.

13. A predictive traffic information creating apparatus according to claim 8 further being connected via the communication network to a traffic information display terminal that displays traffic information including the predictive traffic information,
and wherein
when receiving a request for delivery of predictive traffic information that is transmitted from the traffic information display terminal, the information processor transmits the created predictive traffic information to the traffic information display terminal.

14. A predictive traffic information creating apparatus according to claim 9 further being connected via the communication network to a traffic information display terminal that displays traffic information including the predictive traffic information,
and wherein
when receiving a request for delivery of predictive traffic information that is transmitted from the traffic information display terminal, the information processor transmits the created predictive traffic information to the traffic information display terminal.

15. A predictive traffic information creating apparatus according to claim 10 further being connected via the communication network to a traffic information display terminal that displays traffic information including the predictive traffic information,
and wherein
when receiving a request for delivery of predictive traffic information that is transmitted from the traffic information display terminal, the information processor transmits the created predictive traffic information to the traffic information display terminal.

16. A traffic information display terminal comprising an operational unit and a display, receiving information for identifying a position or region from the operational unit, and displaying traffic information regarding a road network including the location or the region,
the traffic information display terminal being connected via a communication network to a predictive traffic information creating apparatus that:
comprises information storage for storing traffic statistical information of a predetermined the road network;
detects an incident in the road network based on live traffic information delivered from a traffic information center at a predetermined time interval;
sets predictive environment parameters for predictive traffic information in accordance with the detected incident; and
creates predictive traffic information for links of the road network based on the predictive environment parameters and the statistical traffic information,
the traffic information display terminal:
when the information for identifying the position or the region is input from the operational unit, acquiring this input information for identifying the position or the region;
transmitting a request for delivery of predictive traffic information to the predictive traffic information creating apparatus, with attaching the acquired information for identifying the position or the region;
receiving predictive traffic information regarding the road network including the position or the region that is delivered from the predictive traffic information creating apparatus in response to the request for delivery of predictive traffic information; and
displaying this received predictive traffic information on a display thereof.

17. A traffic information display terminal according to claim 16, wherein the predictive traffic information displayed on the display thereof includes congestion information of at least one boundary link that is connected to an upper side of a restricted link included in a region where the incident has occurred, as well as congestion information of at least one link that is connected to a further upper side of the boundary link.

18. A traffic information display terminal according to claim 17, wherein the congestion information of the boundary link that is displayed on the display thereof further includes information based on stationary traffic volume that that cannot flow from the boundary link into the restricted link and stays in the boundary link.
